(19) United States
(12) Patent Application Publication
(10) Pub. No.: US 2016/0196553 A1
(43) Pub. Date: Jul. 7, 2016

(54) SYSTEM FOR ELECTRONICALLY TRANSFERRING ASSETS

(71) Applicant: Plutus Financial Inc., Saratoga, CA (US)

(72) Inventor: William J. Barhydt, Los Gatos, CA (US)

(21) Appl. No.: 14/590,843

(22) Filed: Jan. 6, 2015

(51) Int. Cl. G06Q 20/38; G06Q 20/32; G06Q 20/06

(52) U.S. Cl. CPC G06Q 20/3829; G06Q 20/06; G06Q 20/3224

(57) ABSTRACT

Methods, systems, and apparatus, including computer programs encoded on a computer storage medium, by a first computing device of a first user, for obtaining an image of a code presented on a display of a second computing device of a second user, deciphering the code to obtain an identifier of the second user and a signature, verifying that the signature is valid and, based thereon, initiating a first transaction: preventing the first user and the second user from entering into any other transactions until the first transaction is completed or canceled, receiving an acceptance of the first user to transfer a first amount of a digital currency to the second user, obtaining a digital currency network address of the second user based on the identifier, initiating the transfer through a digital currency network using the digital currency network address of the second user and a private key of the first user, reporting the transaction to a remote system, receiving a confirmation from the first user that a second amount of a real currency has been received from the first user, and sending a notification to the second device indicating that the transaction is complete.

### BACKGROUND

This specification relates to transferring assets and, more particularly, transferring assets using a digital currency.

Money can be transferred between individuals or entities. For instance, a remittance is a money transfer by a foreign worker at a host country to an individual at his or her home country. The foreign work can deposit money (e.g., cash) at an agent office of a money transferring service (e.g., Western Union) at the host country. The money transferring service then can transfer the money to a bank in the host country (e.g., via an Automated Clearing House or ACH transaction), which in turn can transfer the money to another bank in the home country at a certain exchange rate between currencies of the host and home countries. The bank at the home country then transfers the money to another money transferring service at the home country, which can release the money (e.g., cash in local currency) to the individual via a local agent office. The cost for the money transfer can be high because of multiple steps taken by multiple institutions between the foreign worker at the host country and the individual at the home country.

A digital currency is a medium of exchange for trades that is processed and stored electronically. A crypto currency such as Bitcoin is a digital currency that uses cryptography to complete transactions. A transaction or payment in Bitcoin from a first user to a second user can be processed by a peer-to-peer computer network. The peer-to-peer computer network verifies the transaction based on the first user's public encryption key, and records the transaction in a data structure (e.g., a block chain) using the second user's public encryption keys.

### SUMMARY

In general, one aspect of the subject matter described in this specification can be embodied in methods that include the actions of, by a first computing device of a first user, obtaining an image of a code presented on a display of a second computing device of a second user, deciphering the code to obtain an identifier of the second user and a signature, verifying that the signature is valid and, based thereon, initiating a first transaction: preventing the first user and the second user from entering into any other transactions until the first transaction is completed or canceled, receiving an acceptance of the first user to transfer a first amount of a digital currency to the second user, obtaining a digital currency network address of the second user based on the identifier, initiating the transfer through a digital currency network using the digital currency network address of the second user and a private key of the first user, reporting the transaction to a remote system, receiving a confirmation from the first user that a second amount of a real currency has been received from the first user; and sending a notification to the second device indicating that the transaction is complete.

Other embodiments of this aspect include corresponding systems, apparatus, and computer programs. These and other aspects can optionally include one or more of the following features. After deciphering the code and before initiating the first transaction, the aspect can comprise presenting a picture of the second user, and receiving confirmation from the first user that the second user matches the picture. The aspect can further comprise, by the second computing device, receiving an indication that the digital currency in the first amount has been received, obtaining a digital currency network address of a third user, and initiating a transfer at least part of the received digital currency to the third user through the digital currency network using the digital currency network address of the third user and a private key of the second user. The aspect can further comprise, by the second computing device, obtaining the geographic location of the first user from the remote system. The aspect can further comprise, by the remote system, obtaining a derivative financial instrument based on the first amount of the digital currency at a current exchange rate wherein the derivative protects against a drop in the exchange rate of the digital currency for a limited time period. The code can be a two or three dimensional bar code. The second amount of the real currency can further comprise a transaction fee. The aspect can further comprise, by the second computing device, obtaining a digital currency network address of the remote system, and initiating, through the digital currency network using the digital currency network address of the remote system and a private key of the second user, a second transfer of a third amount of the digital currency from the second user to the remote system.

Another aspect of the subject matter described in this specification can be embodied in methods that include the actions of, by a first computing device of a first user, obtaining an image of a code presented on a display of a second computing device of a second user, deciphering the code to obtain an identifier of the second user and a signature, verifying that the signature is valid and, based thereon, initiating a first transaction: preventing the first user the second user from entering into any other transactions until the first transaction is completed or canceled, receiving an acceptance of the first user to transfer a first amount of a digital currency from the second user to the first user, and sending, to the second computing device, a first notification indicating the acceptance; and receiving, from the second computing device, a second notification indicating the transfer of the first amount of the digital currency has been initiated.

Other embodiments of this aspect include corresponding systems, apparatus, and computer programs. These and other aspects can optionally include one or more of the following features. Based on the first notification, the second computing device can perform obtaining a digital currency network address of the first user, initiating the transfer through a digital currency network using the digital currency network address of the first user and a private key of the second user, reporting the transaction to a remote system, receiving a confirmation from the second user that a second amount of a real currency has been received by the second user, and sending the second notification to the first device, the second notification further indicating that the transaction is complete. The aspect can comprise, after deciphering the code and before initiating the first transaction, presenting a picture of the second user, and receiving confirmation from the first user that the second user matches the picture. The second computing device can further perform, obtaining the geographic location and an identifier of the first user from the remote system, and obtaining a digital currency network address of the first user based on the identifier. The aspect can further comprise, by the remote system, obtaining a derivative financial instrument based on the first amount of the digital currency at a current exchange rate wherein the derivative protects against a drop in the exchange rate of the digital currency for a limited time period. The code can be a two or three dimensional bar code. The first amount of the digital currency can further comprise a transaction fee. The second computing device can further perform, obtaining a digital currency network address of the remote system, and initiating, through the digital currency network using the digital currency network address of the remote system and a private key of the second user, a second transfer of a third amount of the digital currency from the second user to the remote system.

Particular implementations of the subject matter described in this specification can be implemented to realize one or more of the following advantages. The system described herein provides a money transfer service between a first consumer and a second consumer. Instead of transferring money in real currencies between the first and second consumers through multiple institutions, the system can provide an end-user software application running on respective computing devices of the first and second consumers to facilitate transferring money between the first and second consumers, by using digital currency transfers through a digital currency network. The system can provide a network of tellers, and maintain user records for the consumers and tellers. Each user record can comprise a mapping between an identifier of a consumer or a teller, and a respective public encryption key for digital currency transfers through the digital currency network. The first consumer can use the end-user software application to find a nearby teller of the money transfer service, and deposit to the teller money to be transferred, in exchange for an amount of a digital currency. Using the end-user software application, the first consumer can send the amount of the digital currency to the second consumer through the digital currency network. The second consumer then can use the end-user software application to find another local teller, and withdraw the transferred money from the other teller by exchanging with the amount of the digital currency.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for a money transfer service.

FIGS. 2A-2C illustrate user interface examples of an end-user software application running on a computing device of a consumer.

FIGS. 3A and 3B illustrate user interface examples of an end-user software application running on a computing device of a teller.

FIGS. 4A and 4B illustrate user interface examples of an end-user software application running on a computing device of another consumer.

FIGS. 5A and 5B illustrate user interface examples of an end-user software application running on a computing device of another teller.

FIG. 6 is a flowchart of an example method for transferring digital currency in exchange for cash.

FIG. 7 is a flow chart of an example method for receiving digital currency in exchange for cash.

Like reference numbers and designations in the various drawings indicate like elements.

### DETAILED DESCRIPTION

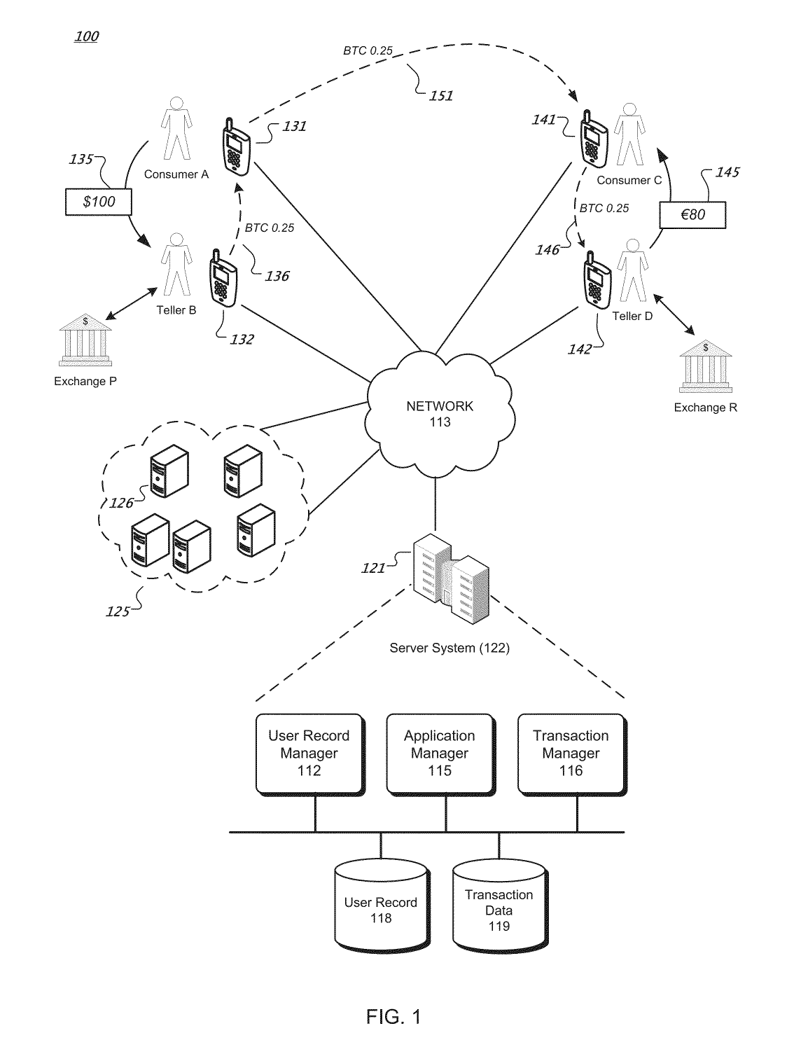

Consumers can use a money transfer service by exchanging money in real currencies (e.g., US dollars, Euros, Mexican Pesos, Chinese RMB) with tellers of the money transfer service. FIG. 1 illustrates an example system for a money transfer service. In the example of FIG. 1, a consumer A in one country (e.g., US) uses the money transfer service to transfer money to a consumer C in another country (e.g., Germany), or in the same country as the consumer A. For instance, the consumer A can deposit money 135 in the respective local currency (e.g., one hundred US dollars or $100) to a teller B of the money transfer service. A teller D of the money transfer service then releases the transferred money 145 in the respective local currency (e.g., eighty Euros or [symbol] 80) to the consumer C.

Instead of transferring money in real currencies between the tellers B and D (for the consumers A and C) through multiple institutions, the money transfer service illustrated in FIG. 1 uses a digital currency as a medium of exchange, for example. In some implementations, the digital currency is Bitcoin. Other digital currencies are possible.

In the example of FIG. 1, a server system 122 provides functionality for managing user data and user application for the money transfer service. A user of the money transfer service can be a consumer or a teller, for example.

The server system 122 comprises software components and databases that can be deployed at one or more data centers 121 in one or more geographic locations, for example. The server system 122 software components comprise a user record manager 112, an application manager 115, and a transaction manager 116. The software components can comprise subcomponents that can execute on the same or on different individual data processing apparatus. The server system 122 databases comprise a user record database 118 and a transaction data database 119. The databases can reside in one or more physical storage systems. The software components and data will be further described below.

A user can use a computing device to access the server system 122 through one or more data communication networks 113 such as the Internet, for example. A computing device of a user (e.g., 131 for the consumer A, 132 for the teller B, 141 for the consumer C, 142 for the teller D) can be a smartphone, a digital watch, a tablet computer, or a personal computer. Other user computing devices are possible.

More particularly, a user accesses the server system 122 and interacts with other users of the money transfer service by using an end-user software application running on the user's computing device. The end-user software application can be provided by the server system 122 of the money transfer service, for example. The user can use the user's computing device to access the server system 122 (e.g., via a web address for the server system 122) and request a copy of the end-user software application. Based on the request, the application manager 115 can provide a copy (or an installation package) of the end-user software application to the user's computing device. The user can install the end-user software application on the user's computing device, and sign up for the money transfer service by providing an identifier. An identifier can be a phone number, an email address, or a text string. Other user identifiers are possible. In addition, the end-user software application generates a private encryption key and stores the private encryption key locally in the user's computing device. The private encryption key can only be accessible by the end-user software application running on the user's computing device. The end-user software application also creates a public encryption key corresponding to the private encryption key, and sends the public encryption key to the server system 122. The application manager 115 can store the user's public encryption key with the user's identifier in the user record database 118.

The user record database 118 stores user data. More particularly, the user record database stores, for each user, a mapping between an identifier of the user and a public encryption key of the user. The identifier-key mapping stored in the user record database 118 can be used to identify a user and facilitate transactions in the digital currency, as will be further described below.

In addition, the application manager 115 can store in the user record database 118 a user's geographical location obtained from the user's computing device. For instance, the end-user software application running on the user's computing device can access the computing device's location data (e.g., based on Global Positioning System or GPS signals, or cellular signals) and sends the location data to the application manager 115.

The end-user software application can provide the user's picture (e.g., a photograph captured by a camera function of the user's computing device) to the server system 122. The application manager 115 can store the user's picture in the user record database 118.

When a user signs up with the money transfer service using the end-user software application, the user signs up as a consumer of the money transfer service. The user can also indicate signing up as a teller, in addition to being a consumer. The user record manager 112 can maintain, for each user's user record stored in the user record database 118, a field indicating whether the user is a teller of the money transfer service, for example.

The money transfer service transfers money by using the digital currency as a medium of exchange. Transactions or payments in the digital currency are processed and stored by a digital currency network 125. The digital currency network 125 can be a peer-to-peer network of computing devices 126, for example. The digital currency network 125 can also include computing devices (e.g., 131, 132, 141, 142) of users of the money transfer service. Computing devices of the digital currency network 125 can communicate with each other through the networks 113, for example.

Transactions related to a user that are processed and stored by the digital currency network 125 can be indexed and searched by the user's address in the digital currency network 125, or the user's digital currency network address. A user's digital currency network address can be the user's public encryption key or a cryptographically hashed copy of the public encryption key. Other examples of a user's digital currency network address are possible.

A first user (e.g., a software program running on behalf of the first user) can initiate a digital currency transfer to a second user through the digital currency network 125 using the second user's digital currency network address and the first user's private encryption key. More particularly, the first user can provide to the digital currency network the first user's digital currency network address (e.g., a public encryption key generated by using the first user's private encryption key), the second user's digital network currency address (e.g., the second user's public encryption key), and a particular amount (e.g., one Bitcoin or BTC 1.00) for a digital currency transfer. Based on the first user's digital currency network address, one or more computing devices 126 of the digital currency network 125 can look up and verify an available (“unspent”) balance of one or more previous digital currency transactions that were paid to the first user and stored in the digital currency network 125. The previous digital currency transactions can also be identified by respective transaction identifiers or indices, for example. The computing devices 126 can also verify that the first user indeed controls the private encryption key corresponding to the first user's public encryption key, by validating a signature provided by the first user.

The computing devices 126 can process and store a new digital currency transaction that takes the particular amount of digital currency out of the available balance of the previous digital currency transactions and transfer (“pay”) the particular amount to the second user, by recording (e.g., in a digital currency ledger) the new digital currency transaction including the particular amount, and the second user's digital currency network address. In this way, the second user can transfer (“spend”) some or all of the particular amount in the new digital currency transaction, to another individual by providing the second user's digital currency network address for another digital currency transaction.

Here, a user (e.g., a software program running on behalf of the user) can have more than one digital currency network addresses in the digital currency network 125. As transaction records in the digital currency network 125 can be viewable to all users (i.e., a public “ledger”), multiple addresses can improve the user's privacy on the digital currency network 125. For instance, a digital currency wallet program can have multiple (e.g., 100) private-public encryption key pairs. The digital currency wallet program can randomly select from the multiple pairs a public encryption key as a digital currency network address for receiving a digital currency transfer from another user through the digital currency network 125. As another example, when receiving a digital currency transfer from another user through the digital currency network 125, a digital currency wallet program can generate a new public encryption key from a new private encryption key. The new private encryption key can be generated from a previously used private encryption key (e.g., by applying a hash function to the previously used private encryption key). In this way, all private encryption keys can be traced back to a “master” private encryption key.

In the money transfer system illustrated in FIG. 1, the consumer A can transfer the money 135 ($100) to consumer C by first depositing the money 135 to the teller B, and more particularly, in exchange for an equivalent amount of the digital currency (BTC 0.25), as indicated by the dashed arrow of a digital currency transfer 136 illustrated in FIG. 1. Here, the exchange rate between the US dollar and the Bitcoin digital currency is assumed to be 400 US dollars for one Bitcoin. The consumer A can then send or transfer the digital currency (BTC 0.25) to consumer C, as indicated by the dashed arrow of a digital currency transfer 151. Consumer C then can receive the transferred money 145 ( [symbol] 80) by exchanging the received digital currency (BTC 0.25) with teller D, as indicated by the dashed arrow 146 of a digital currency transfer 146. Here, the exchange rate between the Euro and the Bitcoin digital currency is assumed to be 320 Euros for one Bitcoin. The digital currency transfers 136, 151, 146 are processed and recorded by the digital currency network 125.

In some implementations, the money 145 the consumer C receives can be an asset other than cash money. For instance, the consumer C can initiate the digital currency transfer 146 in exchange for cellular phone minutes or airtime for a local cellular carrier. That is, the consumer A can deposit the money 135 to the teller B to buy local cellular airtime for the consumer C.

Note that the digital currency transfers 136, 151, and 146 do not have to be of a same amount. For instance, the consumer A can send $80, instead of $100, to the consumer C. In this case, the digital currency transfer 151 has an amount of BTC 0.20, which is less than the amount of BTC 0.25 of the digital currency transfer 136. As another example, the consumer C may combine an amount of another digital currency transfer (e.g., from another user of the money transfer service) with the amount of the digital currency transfer 151 to exchange cash in the local currency with the teller D. In this case, an amount of the digital currency transfer 146 is greater than the amount of the digital currency transfer 151.

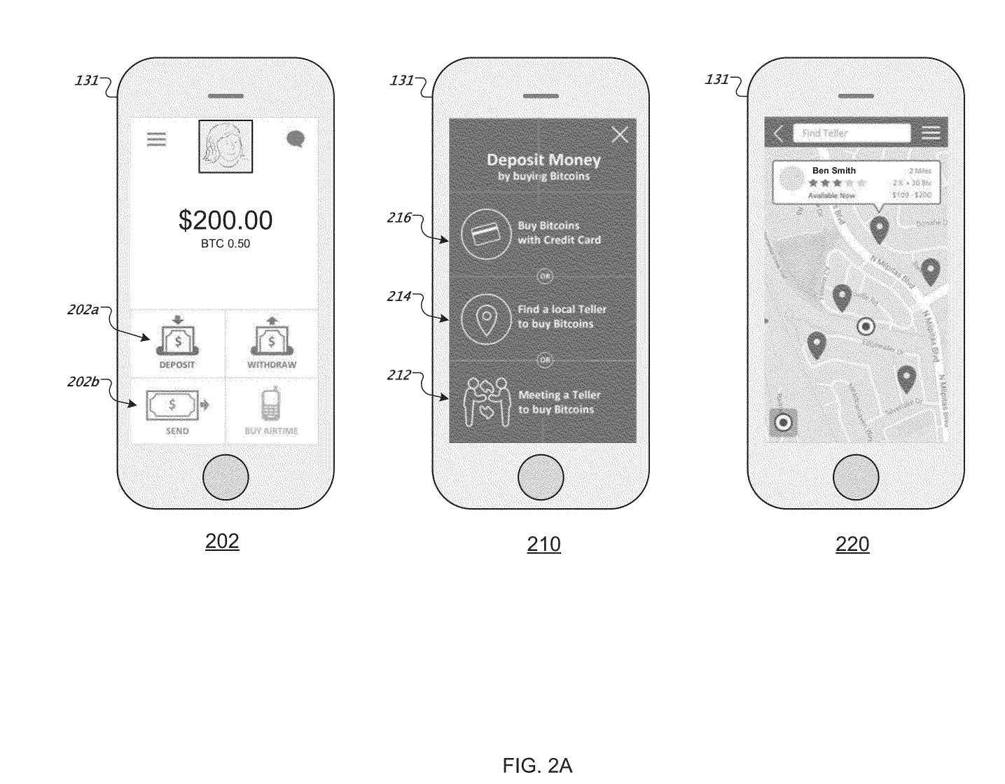

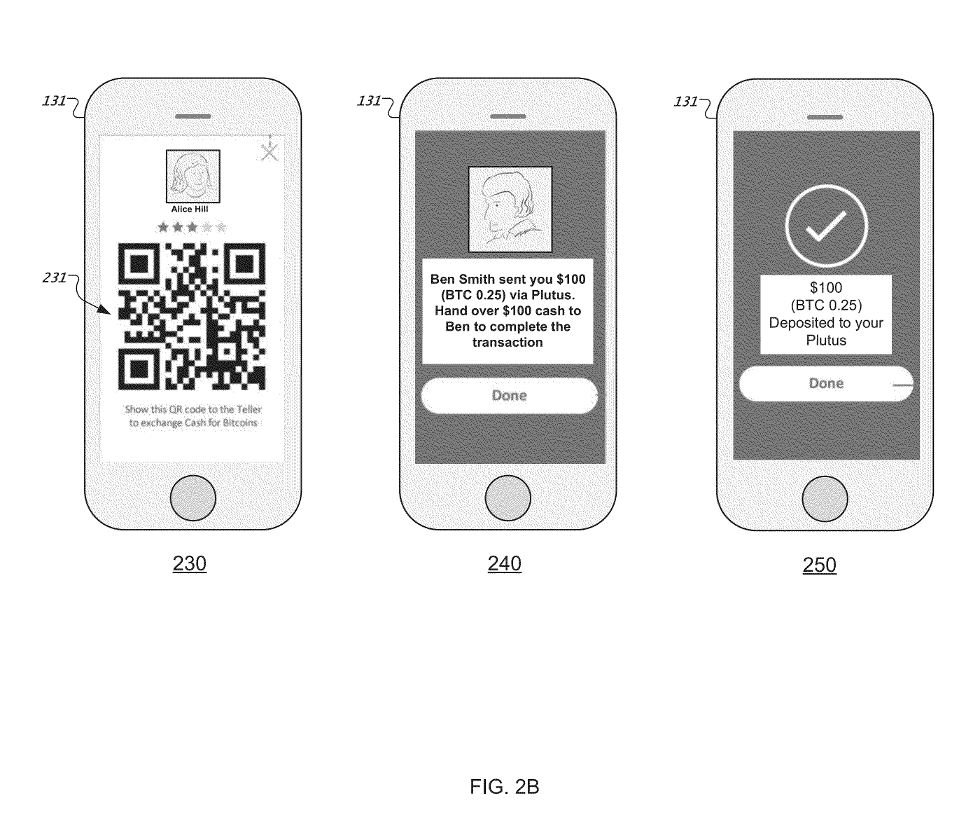

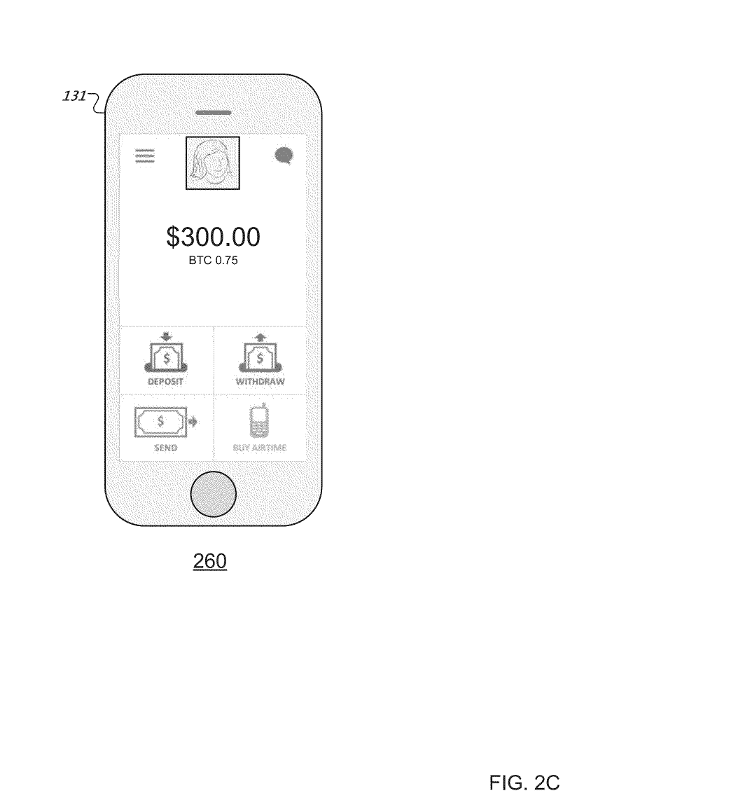

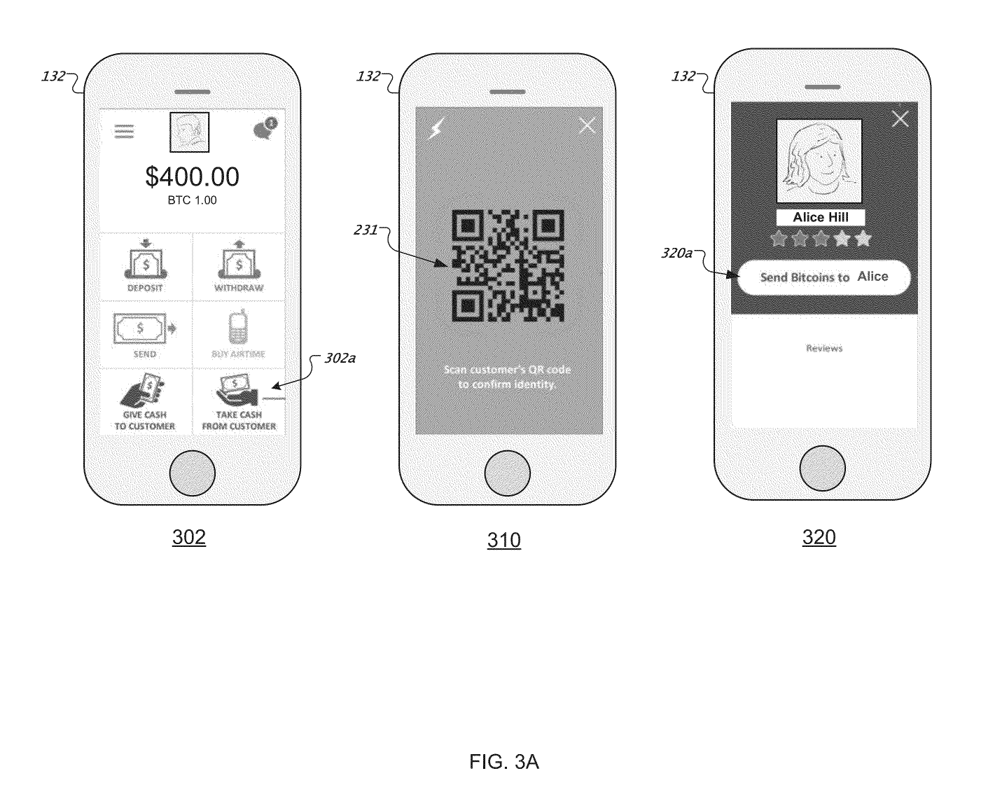

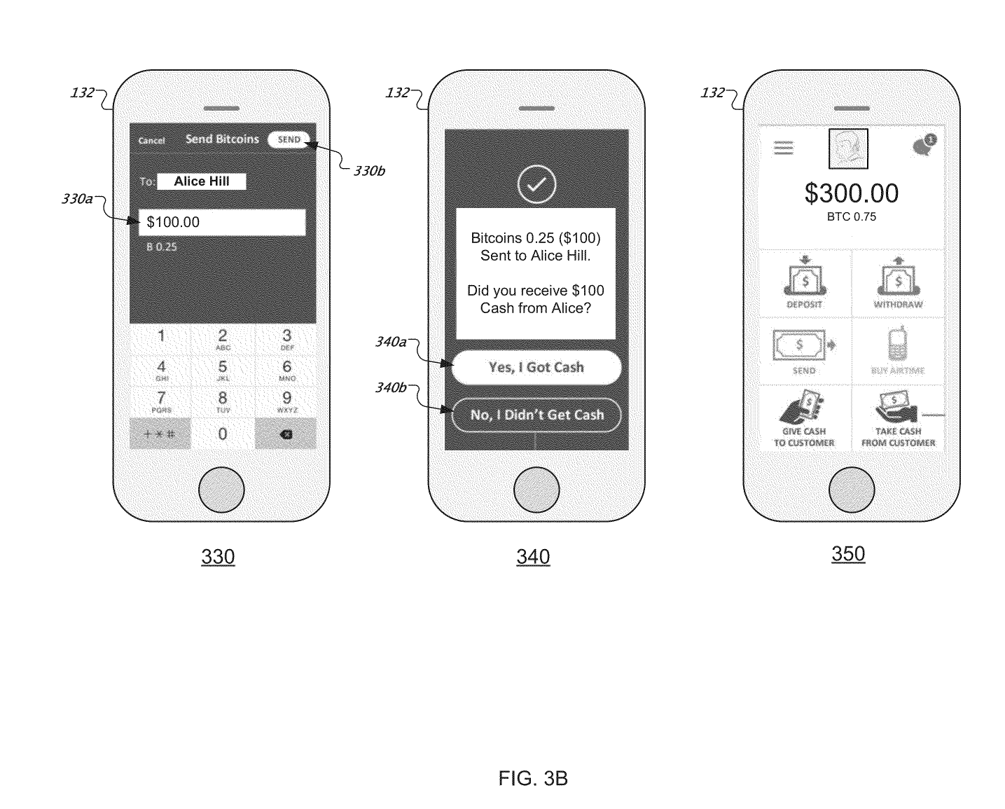

As described earlier, users of the money transfer service can access the server system 122 and interact with other users using the end-user software application provided by the server system 122. FIGS. 2A-2C, 3A, and 3B are user interface examples that illustrate the exchange between the consumer A and the teller B using the end-user software application.

FIGS. 2A-2C illustrate user interface examples of the end-user software application running on the computing device 131 of the consumer A in FIG. 1. In FIG. 2A, a starting user interface 202 of the end-user software application for the consumer A includes a current balance in the digital currency (e.g., $200.00 or BTC 0.50). The starting page 202 also includes selectable icons for user actions in deposit, withdraw, send and buy airtime. In this example, the consumer A selects the deposit icon 202a to deposit cash in exchange for the digital currency. In response to the selection, the end-user software application displays available deposit options in a user interface 210. The user interface 210 includes deposit options in directly meeting a teller to buy the digital currency (212), finding a nearby teller (214), and buying the digital currency with a credit card (216).

If the consumer A selects the finding a nearby teller option (214), the end-user software application can send a request including a location of the consumer A, to the server system 122. Based on the request, the user record manager 112 can access the user record database 118 for a list of tellers near the location of the consumer A (e.g., within two miles) and sends the list of tellers (and their respective locations) to the computing device 131. The end-user software application can display a map indicating tellers near the consumer A, as illustrated in a user interface 220.

When the consumer A (e.g., “Alice Hill”) selects the teller B (e.g., “Ben Smith”) from the map, or when the consumer A selects the option 212 when meeting with the teller B, the end-user software application can display a user interface 230 including an image of a code 231 that can be shown to the teller B for exchanging cash money for the digital currency. The code can be a one-dimensional bar code, a two-dimensional bar code (e.g., Quick Response or QR code), or a three-dimensional bar code. Other code examples are possible. The code includes an identifier of the consumer A and a signature for the money transfer service, for example. The identifier can be the user identifier or the public encryption key of the consumer A that is stored in the identifier-key mapping in the user record database 118 described earlier. The user interface 230 can also include a picture of the consumer A

FIGS. 3A and 3B illustrate user interface examples of the end-user software application running on the computing device 132 of the teller B illustrated in FIG. 1. In FIG. 3A, a user interface 302 of the end-user software application for the teller B includes a current balance in the digital currency (e.g., $400 or BTC 1.00). The starting page 302 includes selectable icons for user actions available for a teller in giving cash to customer and taking cash from customer. The starting page 302 also includes selectable icons for user actions available to a consumer (deposit, withdraw, send, and buy airtime).

When the consumer A and the teller B meet in person, the teller B can select the take cash from customer icon 302a, causing the end-user software application on the computing device 132 to display a user interface 310 for capturing the code image 231 that is displayed by the end-user software application running on the computing device 131 of the consumer A. The end-user software application on the computing device 132 of the teller B can decipher the code and obtain the identifier of the consumer A and the signature. The end-user software application on the computing device 132 of the teller B can verify that the code was generated by another copy of the end-user software application of the money transfer service by verifying the signature, for example. If the signature is verified, the end-user software application on the computing device 132 of the teller B can verify the identity of the consumer A by providing the identifier in the code to the user record manager 112, which in turn determines whether the identifier corresponds to a user record stored in the user record database 118.

In addition, the end-user software application on the computing device 132 of the teller B can retrieve (e.g., via the user record manager 112) a picture of the consumer A from the user record database 118, and display the picture to the teller B in a user interface 320. The teller B can confirm the identity of the consumer A—e.g., by comparing the consumer A in person and the picture shown in the user interface 320, select “Send Bitcoins to Alice” icon 320a, enter a particular amount 330a (e.g., $100 or BTC 0.25) for the digital currency transfer 136 in a user interface 330 in FIG. 3B, and select “send” icon 330b in the user interface 330 to indicate an intent to initiate the digital currency transfer 136 to the consumer A.

Based on the teller B's indication of an intent to initiate the digital currency transfer 136 to the consumer A, the end-user software application on the computing device 132 of the teller B can send a notification to the computing device 131 of the consumer A, causing the end-user software application on the computing device 131 to display, in a user interface 240 in FIG.

2B, a message about the teller B's intention to initiate the digital currency transfer 136 to the consumer A, and for requesting the consumer A to hand over the money 135 (to be transferred to the consumer C). In some implementations, the money 135 can further comprise a teller transaction fee (e.g., one percent or one dollar) to compensate the teller B.

The notification can also include the teller B's identifier for the money transfer service. The end-user software application on the computing device 131 of the consumer A can retrieve a picture of the teller B from the user record database 118 (e.g., via the user record manager 112) based on the teller B's identifier, and display the teller B's picture in the user interface 240. In this way, the consumer A can verify the teller B's identify by comparing the picture with the teller B in person, before handing over the money 135 to the teller B.

Here, the end-user software application on the computing device 132 of the teller B does not initiate another digital currency transfer through the digital currency network 125 before the digital currency transfer 136 is completed or canceled.

After the consumer A hands over the money 135 to the teller B, the teller B can confirm receiving the money 135 from the consumer A in a user interface 340 (FIG. 3B) displayed by the end-user software application on the computing device 132 of the teller B—e.g., by selecting “Yes, I Got Cash” icon 340a. Based on the teller B's confirmation, the end-user software application on the computing device 132 of the teller B can initiate the digital currency transfer 136 from the teller B to the consumer A through the digital currency network 125. As described earlier, the end-user software application on the computing device 132 of the teller B can initiate the digital currency transfer 136 through the digital current network 125 using the teller B's private encryption key (stored locally in the computing device 132), and the consumer A's digital currency network address—e.g., the consumer A's public encryption key. The end-user software program on the computing device 131 of the teller B can obtain the consumer A's public encryption key from the image code 231, if the public encryption key is already included in the image code 231. The end-user software program on the computing device 131 of the teller B can also obtain the consumer A's public encryption key from the user record database 118 by querying the database (e.g., via the user record manager 112) with the consumer A's identifier (included in the image code 231). The end-user software program on the computing device 131 of the teller B can provide to the digital currency network 125 the teller B's public encryption key (e.g., generated from the locally stored private encryption key), the consumer A's public encryption key, and the amount for the digital currency transfer 136. The digital currency network 125 then can process and store a transaction corresponding to the digital currency transfer 136.

If the teller B does not receive the money 135 from the consumer A, the teller B can cancel (i.e., not initiate) the digital currency transfer 136 through the digital currency network 125 by selecting “No, I didn't get cash” icon 340b in the user interface 340, for example. Based on the teller B's selection, the end-user software application on the computing device 132 of the teller B can display a message confirming that the digital currency transfer 136 is canceled. In addition, the end-user software application on the computing device 132 of the teller B can send a notification to the computing device 131 of the consumer A, causing the end-user software application on the computing device 131 to display a message confirming that the digital currency transfer 136 is canceled.

After initiating the digital currency transfer 136 through the digital currency network 125, the end-user software application on the computing device 132 of the teller B can display in a starting page 350 a remaining balance in the digital currency (e.g., $300 or BTC 0.75) for the teller B. In addition, the end-user software application on the computing device 132 of the teller B can send a notification to the computing device 131 of the consumer A, causing the end-user software application on the computing device 131 to display in a user interface 250 indicating that the digital currency transfer 136 has been initiated. In addition, the end-user software application on the computing device 131 of the consumer A can display in a starting page 260 with a new balance in the digital currency (e.g., $300 or BTC 0.75).

As illustrated in FIG. 1, the consumer A can transfer the money 135 to the consumer C by transferring the equivalent digital currency (e.g., exchanged with the teller B through the digital currency transfer 136) to the consumer C, as indicated by the dashed arrow of the digital currency transfer 151. The consumer A can use the end-user software application on the computing device 131 to initiate the digital currency transfer 151 by selecting the “send” user action icon 202b illustrated in the starting page 202, and providing the end-user software application a selection of the consumer C (e.g., from a contact list menu in the end-user software application).

The end-user software application on the computing device 131 of the consumer A can initiate the digital currency transfer 151 through the digital currency network 125 using the consumer A's private encryption key (stored locally in the computing device 131), and the consumer C's digital currency network address—e.g., the consumer C's public encryption key. The end-user software program on the computing device 131 of the consumer A can obtain the consumer C's public encryption key from the user record database 118 by querying the database (e.g., via the user record manager 112) with the consumer C's identifier (e.g., a phone number). If the consumer C's public encryption key is not available in the user record database 118—i.e., the consumer C has not signed up the money transfer service of FIG. 1, the end-user software application on the computing device 131 of the consumer A can send a push notification (e.g., a text message) to the consumer C's computing device 141. The push notification requests the consumer C to download a copy of the end-user software application from the server system 122 (e.g., via a web address in the push notification) and sign up the money transfer service, as described earlier.

The end-user software application on the computing device 131 on the consumer A then can provide to the digital currency network 125 the consumer A's public encryption key (e.g., generated from the locally stored private encryption key), the consumer C's public encryption key, and the amount of the digital currency transfer 151. The digital currency network 125 then can process and store a transaction corresponding to the digital currency transfer 151.

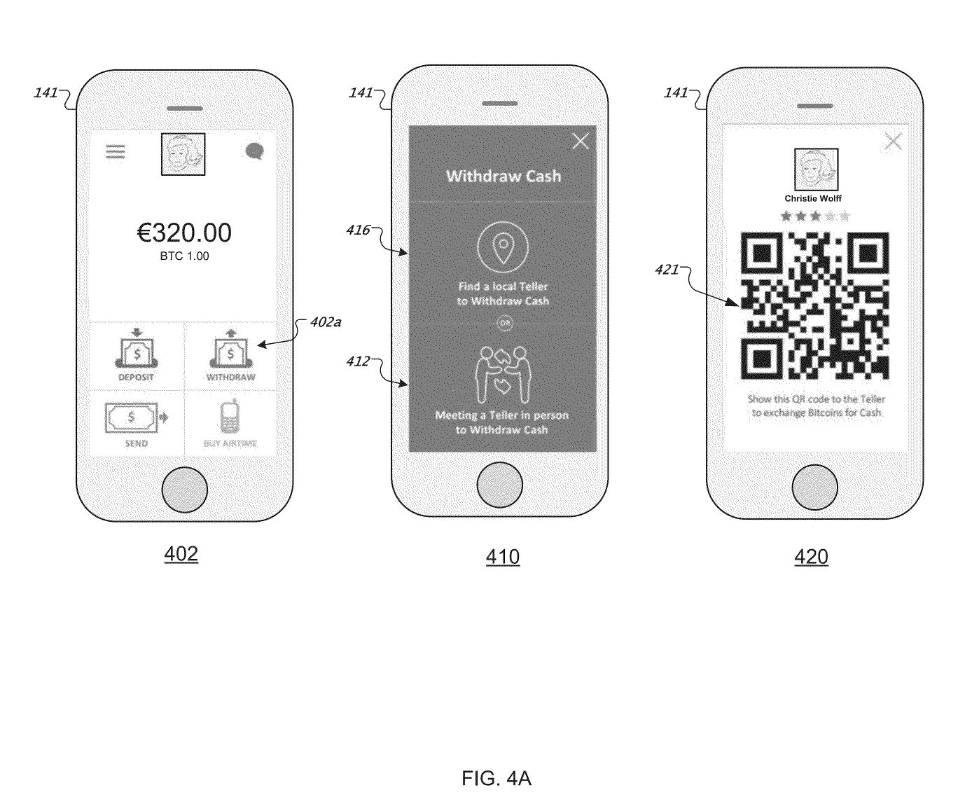

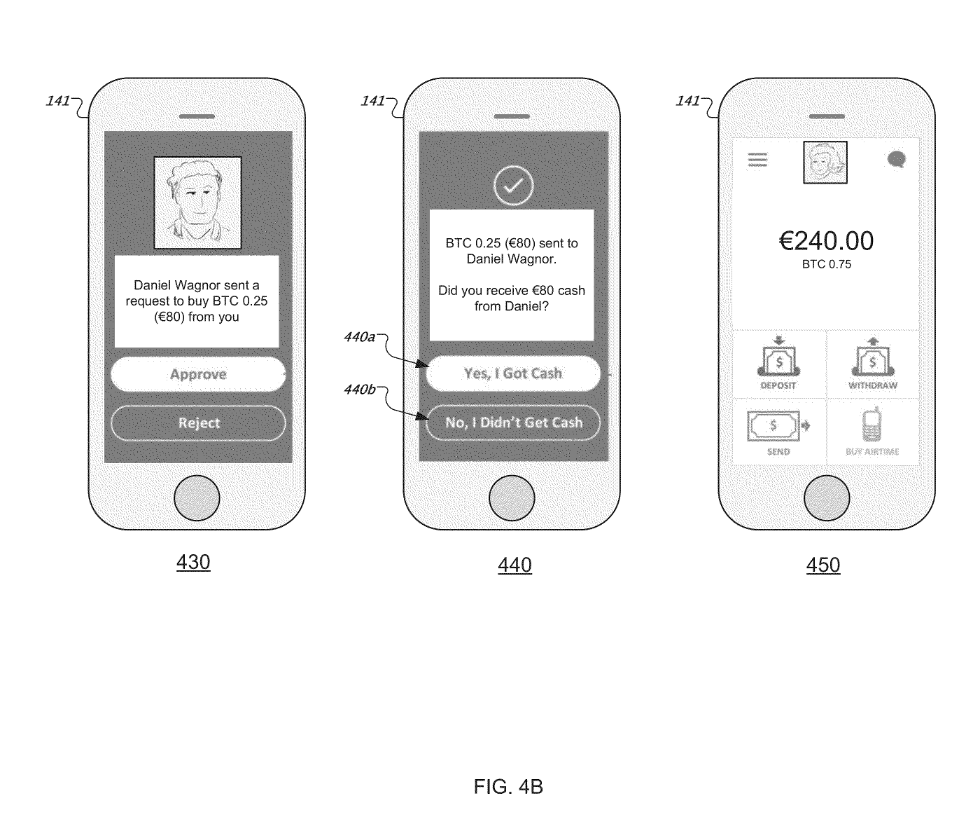

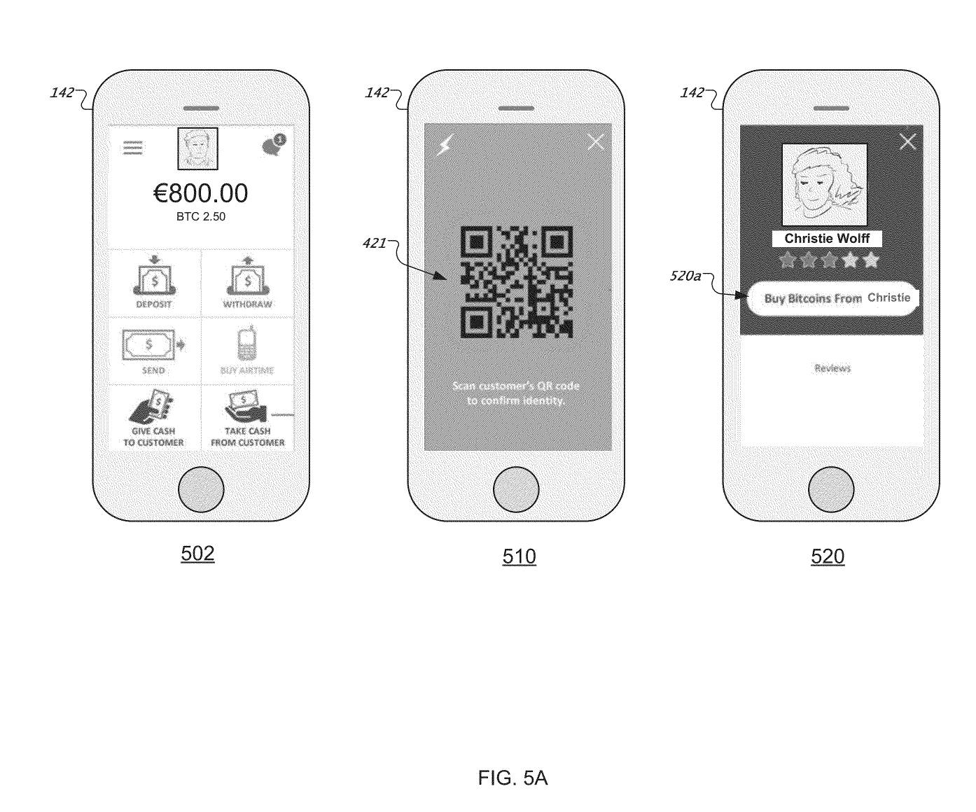

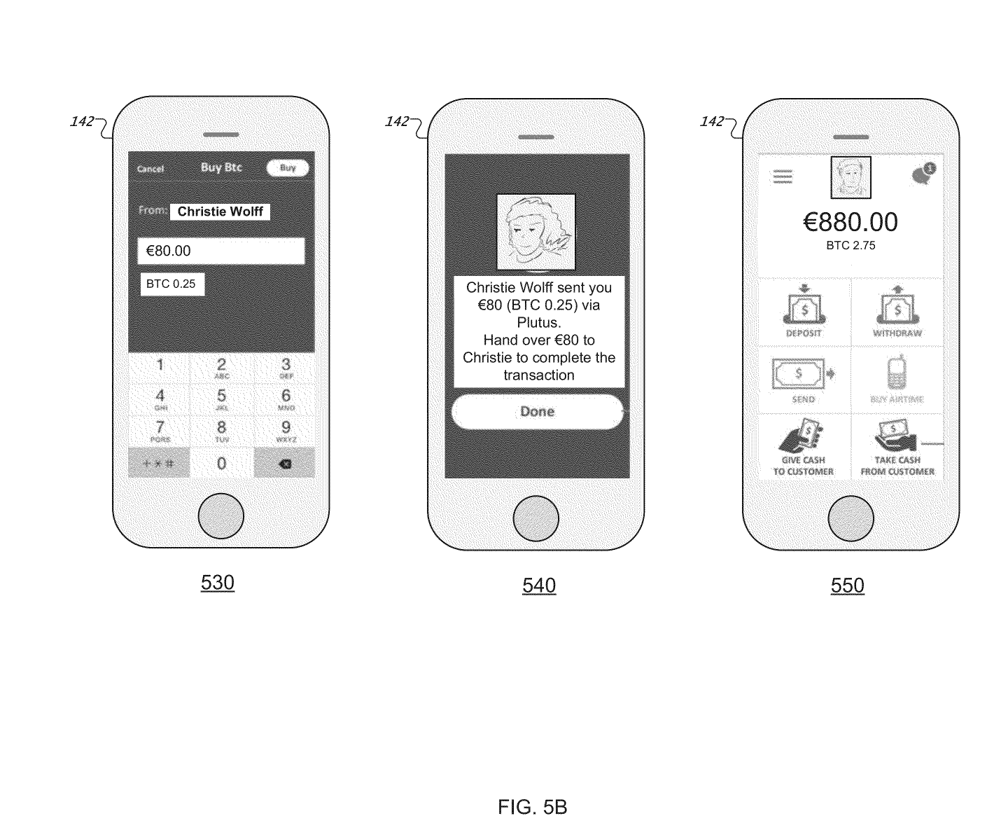

As described earlier, the consumer C can receive the transferred money 145 from the teller D by exchanging with the teller D the digital currency that is received from the consumer A via the digital currency transfer 151. FIGS. 4A, 4B, 5A, and 5B are user interface examples that illustrate the exchange between the consumer C and the teller D using the end-user software application.

FIGS. 4A and 4B illustrate user interface examples of the end-user software application running on the computing device 141 of the consumer C in FIG. 1. In FIG. 4A, a starting page 402 of the end-user software program for the consumer C includes a current balance in the digital currency (e.g., [symbol] 320.00 or BTC 1.00). The consumer C can select the withdraw icon 402a to withdraw cash in exchange for the digital currency. In response to the selection, the end-user software application displays available withdrawal options in a user interface 410. The user interface 410 includes an option 416 in finding a nearby teller, and another option 412 in withdrawing cash from a teller.

If the consumer C selects the option 416, the end-user software application can send a request including a location of the consumer C, to the server system 122. Based on the request, the user record manager 112 can access the user record database 118 for a list of tellers near the location of the consumer A and sends the list of tellers (and their respective locations) to the computing device 131. The end-user software application can, for example, display a map indicating tellers near the consumer C.

When the consumer C (e.g., “Christie Wolff”) selects the teller D (e.g., “Daniel Wagnor”) from the map, or when the consumer C selects the option 412 when meeting with the teller D, the end-user software application can display a user interface 420 an image 421 of a code that can be shown to the teller D for exchanging cash money for the digital currency. The code can be a one-dimensional bar code, a two-dimensional bar code (e.g., Quick Response or QR code), or a three-dimensional bar code. Other code examples are possible. The code includes an identifier of the consumer C and a signature for the money transfer service. The identifier can be the user identifier or the public encryption key of the consumer C that is stored in the identifier-key mapping in the user record database 118 described earlier. The user interface 420 can also include a picture of the consumer C.

FIGS. 5A and 5B illustrate user interface examples of the end-user software application running on the computing device 142 of the teller D in FIG. 1. A starting page 502 shows user actions available to the teller D. The teller D can select the user action of giving cash to customer in the starting page 502 when meeting with the consumer C in person. Based on the selection, the end-user software application on the computing device 142 can display a user interface 510 for capturing the code image 421 that is displayed by the end-user software application running on the computing device 141 of the consumer C. The end-user software application on the computing device 142 can decipher the code and obtain the identifier of the consumer C and the signature. The end-user software application on the computing device 142 of the teller D can verify that the code was generated by another copy of the end-user software application of the money transfer service by verifying the signature. If the signature is verified, the end-user software application on the computing device 142 of the teller D can verify the identity of the consumer C by providing the identifier in the code to the user record manager 112, which in turn determines whether the identifier corresponds to a user record stored in the user record database 118.

In addition, the end-user software application on the computing device 142 of the teller D can retrieve a picture of the consumer C from the user record database 118, and display the picture to the teller D in a user interface 520. The teller D can confirm the identity of the consumer C by comparing the consumer C in person and the picture shown in the user interface 520, for example. The teller D can select “Buy Bitcoins from Christie” icon 520a in the user interface 520, enter a particular amount (e.g., [symbol] 80 for BTC 0.25) for the digital currency transfer 146 in a user interface 530 in FIG. 5B. Based on the selection, the end-user software application on the computing device 142 of the teller D sends a notification to the computing device 141 of the consumer C. The notification can also include the teller D's identifier for the money transfer service. Based on the notification, the end-user software application on the computing device 141 of the consumer C can display in a user interface 430 (in FIG. 4B) a message indicating the teller D's request for initiating the digital currency transfer 146 from the consumer C to the teller D. The end-user software application on the computing device 141 can use the teller D's identifier and retrieve a picture of the teller B from the server system 122 and display the picture in the user interface 430. In this way, the consumer C can verify the teller D's identify by comparing the picture in the user interface 430 and the teller D in person.

In some implementations, the amount of the digital currency transfer 146 can further comprise a teller transaction fee (e.g., one percent or BTC 0.02) for compensating the teller D.

If the consumer C approves the request in the user interface 430, the end-user software application on the computing device 141 of the consumer C sends to the computing device 142 of the teller D another notification, indicating the consumer C's intention to initiate the digital currency transfer 146. Based on the notification from the computing device 141, the end-user software application on the computing device 142 of the teller D display, in a user interface 540, a message about the consumer C's intention to initiate the digital currency transfer 146, and for requesting the teller D to hand over the money 145 to the consumer C.

After receiving the money 145 from the teller D, the consumer C can confirm receiving the transferred money 145 from the teller D in a user interface 440 displayed by the end-user software application on the computing device 141 of the consumer C (e.g., by selecting “Yes, I got cash” icon 440a). Based on the consumer C's confirmation, the end-user software application on the computing device 141 of the consumer C can initiate the digital currency transfer 146 through the digital currency network 125. As described earlier, the end-user software application on the computing device 141 can initiate the digital currency transfer 146 through the digital currency network 125 using the consumer C's private encryption key (stored locally in the computing device 141), and the teller D's digital currency network address--e.g., the teller D's public encryption key. The end-user software application on the computing device 141 of the consumer C can obtain the teller D's public encryption key from the user record database 118 by querying the database with the teller D's identifier. The end-user software application on the computing device 141 of the consumer C can provide to the digital currency network 125 the consumer C's public encryption key (e.g., generated from the locally stored private encryption key), the teller D's public encryption key, and the amount for the digital currency transfer 146. The digital currency network 125 then can process and store a transaction corresponding to the digital currency transfer 146.

If the consumer C does not receive the transferred money 145 from the teller D, the consumer C can cancel (i.e., not initiate) the digital currency transfer 146 through the digital currency network 125 by selecting “No, I didn't get cash” icon 440b in the user interface 440. Based on the consumer C's selection, the end-user software application on the computing device 141 of the consumer C can display a message confirming that the digital currency transfer 146 is canceled. In addition, the end-user software application on the computing device 141 of the consumer C can send a notification to the computing device 142 of the teller D, causing the end-user software application on the computing device 142 to display a message confirming that the digital currency transfer 146 is canceled.

After initiating the digital currency transfer 146 through the digital currency network 125, the end-user software application on the computing device 141 of the consumer C can display in a starting page 450 a remaining balance in the digital currency (e.g., [symbol] 240.00 or BTC 0.75) for the consumer C. In addition, the end-user software application on the computing device 141 of the consumer C can send a notification to the computing device 142 of the teller D, causing the end-user software application on the computing device 142 to display a message indicating the digital currency transfer 146 has been initiated. The end-user software application on the computing device 142 can display in a starting page 550 with a new balance in the digital currency (e.g., [symbol] 880.00 or BTC 2.75).

To maintain a reasonable amount of reserve in the digital currency, a teller can exchange (buy or sell) the digital currency with a digital currency exchange. For instance, the teller B can exchange the digital currency with an exchange P for cash in US dollars. The teller D can exchange the digital currency with an exchange R for cash in the Euros. To protect a drop in exchange rate for the digital currency for the tellers, the money transfer service can arrange a financial instrument (e.g., a derivative) that hedges against the risk of a drop in the exchange rate of the digital currency. The financial instrument can have a specified duration (e.g., 12 hours, 24 hours). In this way, tellers can be protected from a drop in the value of their digital currency reserves during the specified duration. Consumers can also be protected from a drop in the value of the money being transferred.

By way of illustration, after initiating the digital currency transfer 136, the end-user software application on the computing device 132 can send a notification reporting the digital currency transfer 136 and the corresponding local currency, to the transaction manager 116. Similarly, after initiating the digital currency transfer 146, the end-user software application on the computing device 141 can send a notification reporting the digital currency transfer 146 and the corresponding local currency, to the transaction manager 116. The transaction manager 116 can store information about the digital currency transfers in the transaction data database 119. The transaction manager 116 can determine periodically (e.g., every 6 hours) a total amount of the digital currency exchanged for a particular real currency from the exchanges between the consumers and tellers, and obtain (e.g., through the exchanges P, Q, or another institution) a derivative financial instrument based on the total amount of the digital currency at a current exchange rate. The derivative financial can protect against a drop in the exchange rate of the digital currency with respect to the particular real currency for a limited time period (e.g., 12 hours, 24 hours).

In some implementations, the money transfer service illustrated in FIG. 1 can charge consumers for maintaining a network of tellers servicing money transfer needs (“finder's fees”). For instance, after the digital currency transfer 136 is initiated, the end-user software application on the computing device 131 of the consumer A can initiate a digital currency transfer of a particular amount (e.g., 0.25% of the amount of the digital currency transfer 136) to the transaction manager 116, using the transaction manger's public encryption key (e.g., obtained from the transaction manger 116) and the consumer A's private encryption key (stored locally on the computing device 131). The end-user software application on the computing device 131 can provide to the digital currency network 125 the transaction manager's public encryption key, the consumer A's public encryption key (generated from the locally stored private encryption key), and the particular amount of the digital currency. The digital currency network 125 then can process and store a transaction corresponding to this digital currency transfer.

As for another example, after the digital currency transfer 146 is initiated, the end-user software application on the computing device 141 of the consumer C can initiate a digital currency transfer of a particular amount (e.g., 0.25% of the amount of the digital currency transfer 146) to the transaction manager 116, using the transaction manger's public encryption key (e.g., obtained from the transaction manger 116) and the consumer C's private encryption key (stored locally on the computing device 141). The end-user software application on the computing device 141 can provide to the digital currency network 125 the transaction manager's public encryption key, the consumer C's public encryption key (generated from the locally stored private encryption key), and the particular amount of the digital currency. The digital currency network 125 then can process and store a transaction corresponding to this digital currency transfer.

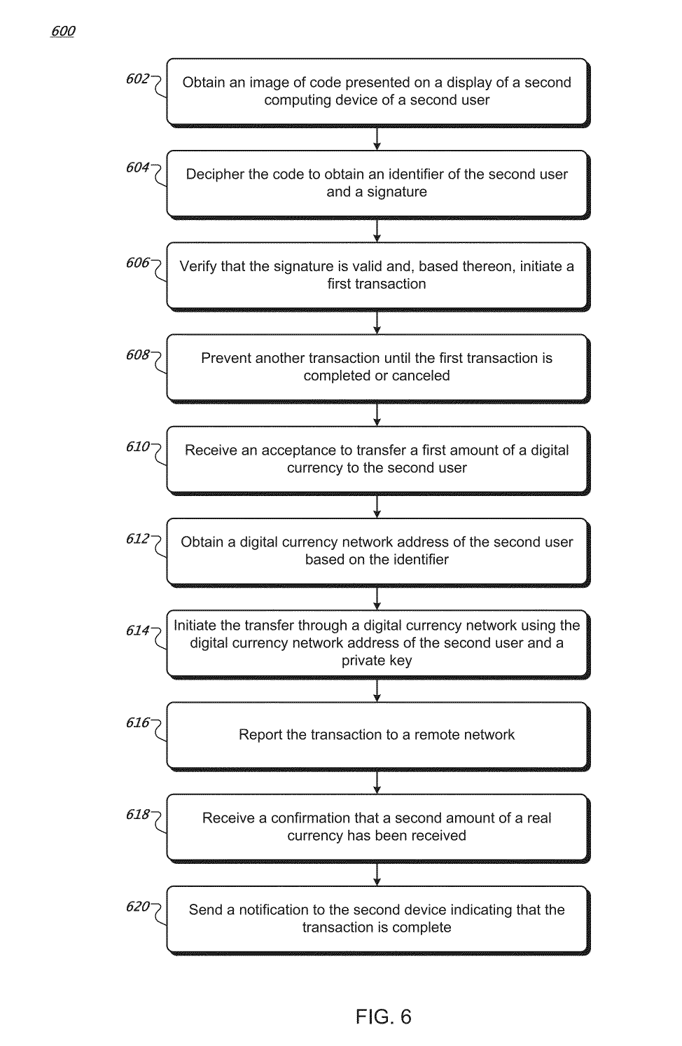

FIG. 6 is a flow chart of an example method for transferring digital currency in exchange for cash. The method can be implemented using the end-user software application running on a user's computing device described earlier. For instance, the method can be implemented using the end-user software application running on the computing device 132 of the teller B. The method, by a first computing device of a first user, begins by obtaining an image of a code presented on a display of a second computing device of a second user (602). The method deciphers the code to obtain an identifier of the second user and a signature. The method verifies that the signature is valid and, based thereon, initiating a first transaction (606). For the first transaction, the method prevents the first user and the second user from entering into any other transactions until the first transaction is completed or canceled (608). The method receives an acceptance of the first user to transfer a first amount of a digital currency to the second user (610). The method obtains a digital currency network address of the second user based on the identifier (612). The method initiates the transfer through a digital currency network using the digital currency network address of the second user and a private key of the first user (614). The method reports the transaction to a remote system (616). The method receives a confirmation from the first user that a second amount of a real currency has been received from the first user (618). The method sends a notification to the second device indicating that the transaction is complete (620).

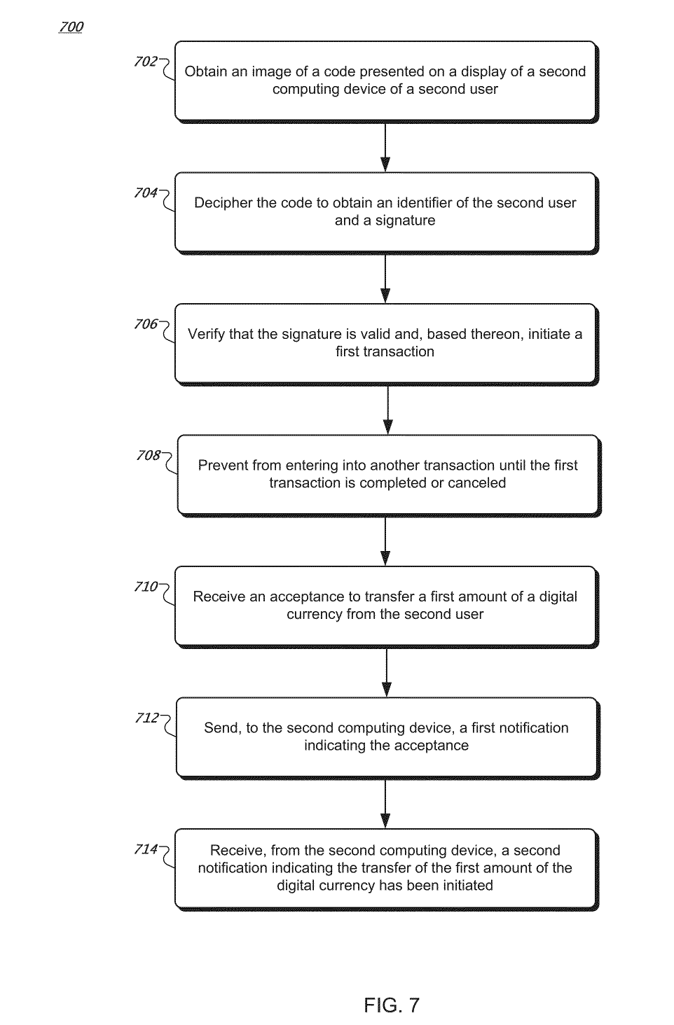

FIG. 7 is a flow chart of an example method for receiving digital currency in exchange for cash. The method can be implemented using the end-user software application running on a user's computing device described earlier. For instance, the method can be implemented using the end-user software application running on the computing device 142 of the teller D. The method, by a first computing device of a first user, begins by obtaining an image of a code presented on a display of a second computing device of a second user (702). The method deciphers the code to obtain an identifier of the second user and a signature (704). The method verifies that the signature is valid and, based thereon, initiating a first transaction (706). For the first transaction, the method prevents the first user and the second user from entering into any other transactions until the first transaction is completed or canceled (708). The method receives an acceptance of the first user to transfer a first amount of a digital currency from the second user to the first user (710). The method sends, to the second computing device, a first notification indicating the acceptance (710). The method receives, from the second computing device, a second notification indicating the transfer of the first amount of the digital currency has been initiated (714).

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by a first computing device of a first user:
obtaining an image of a code presented on a display of a second computing device of a second user;
deciphering the code to obtain an identifier of the second user and a signature;
verifying that the signature is valid and, based thereon:
obtaining a picture of the second user based on the obtained identifier:
providing a graphical user interface comprising the picture of the second user;
receiving input corresponding to user interaction with the graphical user interface and indicating an acceptance of the first user to transfer a first amount of a digital currency to the second user;
obtaining a digital currency network address of the second user based on the identifier;
initiating the transfer through a digital currency network using the digital currency network address of the second user and a private key of the first user;
reporting the transaction to a remote system;
receiving input from the first user indicating that a second amount of a real currency has been received from the second user; and
sending a notification to the second device indicating that the transaction is complete.

2. (canceled)

3. The method of claim 1, further comprising:
performed by the second computing device:
receiving an indication that the digital currency in the first amount has been received;
obtaining a digital currency network address of a third user; and
initiating a transfer at least part of the received digital currency to the third user through the digital currency network using the digital currency network address of the third user and a private key of the second user.

4. The method of claim 1, further comprising:
performed by the second computing device:
obtaining the geographic location of the first user from the remote system.

5. The method of claim 1, further comprising:
performed by the remote system:
obtaining a derivative financial instrument based on the first amount of the digital currency at a current exchange rate wherein the derivative protects against a drop in the exchange rate of the digital currency for a limited time period.

6. The method of claim 1 wherein the code is a two or three dimensional bar code.

7. The method of claim 1 wherein the second amount of the real currency further comprises a transaction fee.

8. The method of claim 4, further comprising:
performed by the second computing device:
obtaining a digital currency network address of the remote system; and
initiating, through the digital currency network using the digital currency network address of the remote system and a private key of the second user, a second transfer of a third amount of the digital currency from the second user to the remote system.

9-16. (canceled)

17. A system comprising:
a first computing device of a first user, the first computing device programmed to perform operations comprising:
obtaining an image of a code presented on a display of a second computing device of a second user;
deciphering the code to obtain an identifier of the second user and a signature;
verifying that the signature is valid and, based thereon:
obtaining a picture of the second user based on the obtained identifier:
providing a graphical user interface comprising the picture of the second user;
receiving input corresponding to user interaction with the graphical user interface and indicating an acceptance of the first user to transfer a first amount of a digital currency to the second user;
obtaining a digital currency network address of the second user based on the identifier;
initiating the transfer through a digital currency network using the digital currency network address of the second user and a private key of the first user;
reporting the transaction to a remote system;
receiving input from the first user indicating that a second amount of a real currency has been received from the first user; and
sending a notification to the second computing device indicating that the transaction is complete.

18. (canceled)

19. The system of claim 17, wherein the second computing device is programmed to perform further operations comprising:
receiving an indication that the digital currency in the first amount has been received;
obtaining a digital currency network address of a third user; and
initiating a transfer at least part of the received digital currency to the third user through the digital currency network using the digital currency network address of the third user and a private key of the second user.

20. The system of claim 17, wherein the second computing device is programmed to perform further operations comprising:
obtaining the geographic location of the first user from the remote system.

21. The system of claim 17, wherein the remote system is programmed to perform further operations comprising:
obtaining a derivative financial instrument based on the first amount of the digital currency at a current exchange rate wherein the derivative protects against a drop in the exchange rate of the digital currency for a limited time period.

22. The system of claim 17 wherein the code is a two or three dimensional bar code.

23. The system of claim 17 wherein the second amount of the real currency further comprises a transaction fee.

24. The system of claim 20, wherein the second computing device is programmed to perform further operations comprising:
obtaining a digital currency network address of the remote system; and
initiating, through the digital currency network using the digital currency network address of the remote system and a private key of the second user, a second transfer of a third amount of the digital currency from the second user to the remote system.

25-30. (canceled)
